(19) United States
(12) Patent Application Publication
(10) Pub. No.: US 2016/0238013 A1
(43) Pub. Date: Aug. 18, 2016

(54) Compressor with Variable Compressor Inlet

(71) Applicant: Continental Automotive GmbH, Hannover (DE)

(72) Inventors: Manfred Weigl, Sinzing (DE); Philippe Grass, Regensburg (DE)

(73) Assignee: Continental Automotive GmbH, Hannover (DE)

(21) Appl. No.: 15/027,021

(22) PCT Filed: Sep. 25, 2014
(86) PCT No.: PCT/EP2014/070499

§ 371 Date: Apr. 4, 2016

(30) Foreign Application Priority Data
Oct. 2, 2013 (DE) 10 2013 220 087.0

(51) Int. Cl. F04D 27/00; F02D 41/00; F04D 29/42

(52) U.S. Cl. CPC F04D 27/003; F04D 29/4206; F02D 41/0007

(57) ABSTRACT

A compressor for a turbocharger may include a compressor wheel with compressor blades mounted in a housing defining a compressor inlet. The compressor inlet may include an inner pipe and an outer pipe surrounding said inner pipe. The inner pipe may be directed toward the radially inner region of the compressor blades and the outer pipe directed toward the radially outer region of the compressor blades. The passage cross section of the outer pipe and/or of the inner pipe may be at least partially shut off by means of shutoff devices.

### CROSS-REFERENCE TO RELATED APPLICATIONS

This application is a U.S. National Stage Application of International Application No. PCT/EP2014/070499 filed Sep. 25, 2014, which designates the United States of America, and claims priority to DE Application No. 10 2013 220 087.0 filed Oct. 2, 2013, the contents of which are hereby incorporated by reference in their entirety.

### TECHNICAL FIELD

The present disclosure relates in general to compressors and, as a specific example, an exhaust gas turbocharger.

### BACKGROUND

Owing to the optimization of spark-ignition engines, with the aim of reducing consumption, requirements on the working range of turbochargers are increasing. The most important reason for this is that the engine is operated with the lowest possible speed but at a high torque to boost efficiency when the engine is under partial load. This mode demands a high boost pressure with a relatively low volume flow. The approach flow to the compressor wheel must therefore be optimized for a wide volume flow range. The need to meet higher future requirements renders it necessary to make the approach flow switchable, so that a large or small flow cross section can be chosen, depending on the volume flow. Thus, it is possible that a sufficiently high approach flow speed to the compressor blades can be achieved not only at a large volume flow but also at a small volume flow. At a low approach flow speed but at a high compressor speed, the approach flow to the blade edge is namely too steep, leading to flow separation. This operating range is referred to as the surge limit.

To solve these problems, turbochargers with air ducts that produce turbulence have been developed, contributing to an improvement in the approach flow angle to the compressor blades at low approach flow speeds. However, these designs cause unnecessary flow resistance at full load.

In another solution, already compressed air is fed back via an annular duct in the compressor inlet. A higher speed of flow in the compressor can thereby be achieved, despite a low intake air volume. However, since this solution impairs the efficiency of the charger within wide ranges, the power of the turbine is insufficient to drive the compressor in passenger vehicle applications.

DE 10 2010 026 176 A1 describes a system in which the speed of flow is increased at a low engine speed by reducing the approach flow cross section. For this purpose, a mechanically relatively complex part is mounted directly in the compressor inlet. It can be critical here that there is not sufficient installation space available for this device and that there are problems with robustness in respect of the number of cycles and temperature loading.

A device and a method for stabilizing the characteristic map of a compressor are known from DE 10 2010 026 176 A1. A cone with a variable angle is arranged on the inner wall of the housing in the inlet region of the compressor. By varying the cone angle, it is thus possible to vary the approach flow cross section of the compressor wheel.

A compressor is known from WO 2013/166 626 A1. In this case, the compressor inlet has an inner pipe and an outer pipe surrounding the latter, wherein the inner pipe is directed toward the radially inner region of the compressor blades. The passage cross section of the inner pipe can be at least partially shut off by means of shutoff devices.

### SUMMARY OF THE INVENTION

The teachings of the present disclosure may be used to provide a compressor which, while having a compressor inlet of particularly simple design, can be operated in a particularly versatile manner. Some embodiments of the present disclosure may be based on the principle of dividing the compressor inlet into two regions, namely an inner region and an annular outer region surrounding the latter. The inner region is formed by the passage cross section of the inner pipe, while the annular outer region is formed by the passage cross section of the outer pipe. Since both regions can be shut off at least partially, the compressor blades can be supplied either via the entire passage cross section of both pipes or only via the annular outer region (passage cross section of the outer pipe) or only via the inner region (passage cross section of the inner pipe). Since it is also possible for the passage cross sections to be shut off only partially, partial supply via the corresponding passage cross section or via both passage cross sections is also possible in each case.

The passage cross section of the compressor inlet can therefore be reduced simply by being shut off, wherein shutoff is performed either in the central inner region or in the radially outer annular region. By (partially) shutting off the inner pipe, the speed of flow in the outer pipe can be increased. Conversely, the speed of flow in the inner pipe can be increased by (partially) shutting off the outer pipe. In this way, the approach flow to the compressor wheel can be optimized over a wide volume flow range. Depending on the volume flow, a large or a small flow cross section can be selected. A sufficiently high approach flow speed to the compressor blades can be achieved not only at a high volume flow but also at a low volume flow.

The compressor inlet comprises two pipes arranged adjacent to one another, of which one is passed into the interior of the other and extends as far as the compressor housing as an inner pipe extending in the outer pipe. Here, therefore, the compressor inlet coming from the header pipe splits into two pipes arranged adjacent to one another, which then make a transition into an inner pipe and an outer pipe surrounding the latter. This embodiment has the advantage that shutoff of the two pipes (inner pipe and outer pipe) can be performed by relatively simple means. In this arrangement, at least one of the pipes arranged adjacent to one another is namely provided with shutoff devices. The shutoff devices are therefore arranged in the region of the separated pipes and not in the region of the concentric pipes (inner pipe and outer pipe), thus enabling them to be of relatively simple design. Slides or simple air flaps, for example, can be used as shutoff devices here, wherein air flaps are particularly preferred since they provide a particularly simple shutoff means.

Embodiments with this feature thus make possible the use, in particular, of a simple air flap to narrow the cross section instead of variable orifice plates of complex configuration. In this case, the air flap is arranged at a distance from the compressor housing, e.g., not in the region of the concentric pipes but in the region of the separated pipes, with the result that the shutoff device or air flap is not situated directly in the inlet region of the compressor housing and it is thereby possible to solve installation-space and temperature problems relatively simply.

As mentioned, the passage cross section of the outer pipe and/or of the inner pipe can be at least partially shut off. Corresponding air flaps or slides may be arranged in both pipes arranged adjacent to one another, but it is also possible for shutoff devices of this kind to be arranged in just one of these pipes. If air flaps are arranged in both pipes arranged adjacent to one another, for example, it is possible to choose during the operation of the compressor whether the outer or the inner region of the compressor blades is to receive the approach flow.

In some embodiments, the compressor has an actuator, which controls the shutoff devices in accordance with an operating parameter of an associated internal combustion engine. An actuator of this kind can control the shutoff devices in accordance with the engine load, for example. In one specific embodiment, a single actuator controls the shutoff devices of both pipes.

For example, an actuator can operate in such a way in this context that, during the transition from full load to partial load, the first passage cross section of the outer pipe is shut off, the corresponding air flap being closed for example, and the passage cross section of the inner pipe is throttled, with the corresponding air flap being partially closed for example, only when there is a further reduction in the load.

In some embodiments, the shutoff devices can replace a throttle valve in the header pipe.

### BRIEF DESCRIPTION OF THE DRAWING

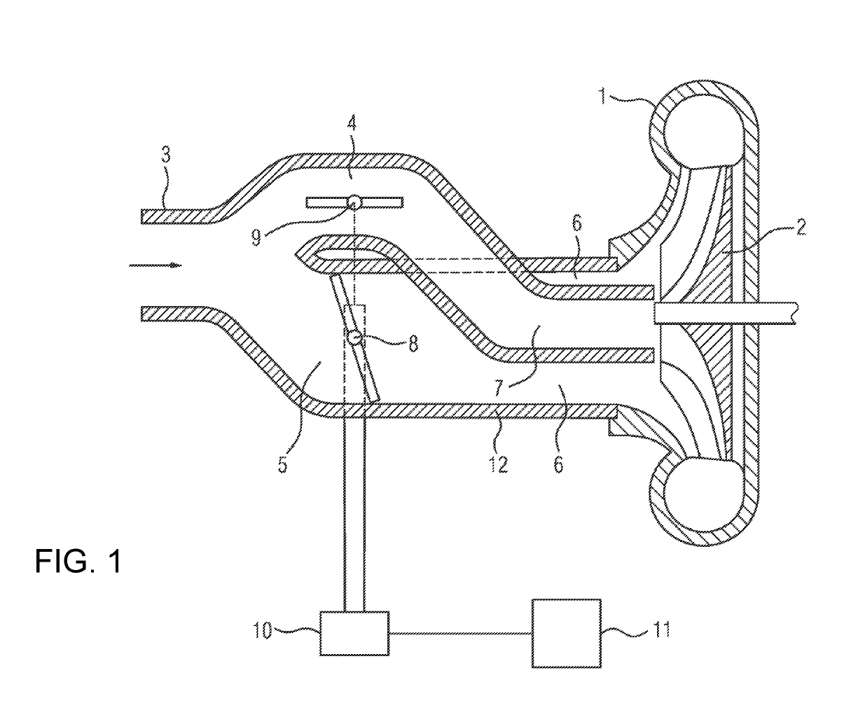

The invention is explained in detail below by means of one illustrative embodiment in conjunction with the drawing. FIG. 1 shows a longitudinal section through the inlet region of a compressor of a turbocharger.

### DETAILED DESCRIPTION

In the corresponding schematic sectional illustration, the compressor housing 1 with the associated compressor inlet 12 is shown. A compressor wheel 2 with corresponding compressor blades (indicated only schematically) is situated in the compressor housing 1. Air flows out of an intake air filter (not shown) into a header pipe 3 and, from there, into the compressor inlet 12. Adjacent to the header pipe 3, the compressor inlet 12 has two separate pipes 4, 5 arranged adjacent to one another, into which the header pipe 3 merges. The upper pipe 4 shown in FIG. 1 extends into the lower pipe 5, and thus two concentric pipes, namely an inner pipe 7 and an outer pipe 6, are formed adjacent to the compressor housing 1 in the region of the compressor inlet 12. In this case, the inner pipe 7 is directed toward the radially inner region and the outer pipe 6 is directed toward the radially outer region of the compressor blades. In cross section, the inner pipe 7 has a circular air passage cross section, while the outer pipe 6 has an annular air passage cross section.

The air coming from the header pipe 3 can therefore flow into the compressor housing 1 in the direction of the compressor both through pipe 4 and the following inner pipe 7 and through pipe 5 and the following outer pipe 6 and act on the compressor blades in different radial regions.

In the region of the pipes 4, 5 arranged adjacent to one another, shutoff devices are arranged in the pipes. In this arrangement, these are air flaps 8, 9, by means of which the corresponding pipe passage cross sections can be shut off completely or partially. When air flap 8 shuts off pipe 5 and hence the outer pipe 6, air then only reaches the compressor via pipe 4 and the inner pipe 7.

Conversely, when air flap 9 shuts off pipe 4 and hence the inner pipe 7, air then only reaches the compressor via pipe 5 and the outer pipe 6. When both air flaps 8, 9 are open, air approaches the compressor blades via the passage cross section of both pipes 6, 7.

The air flaps 8, 9 are controlled by means of an actuator 10 (shown schematically), which is controlled by a control unit 11 of the associated motor vehicle, namely in accordance with the respective load conditions. For engine operation at full load, for example, air flap 8 is open, allowing the full approach flow cross section of the compressor (the full passage cross section of the two pipes 6, 7) to be used. If, however, a high boost pressure is required at a low engine speed and a low air flow rate, e.g., in the Miller cycle, the approach flow speed is too low to avoid flow separation at the leading edges of the compressor blades at a high compressor speed. The charger is then operated beyond the surge limit, entailing a substantial collapse of the boost pressure. Since the resulting approach flow angle is obtained from the respective peripheral speed of the compressor wheel and the approach flow speed, the approach flow speed must be increased for operation with a low air flow rate at a high boost pressure. To increase the approach low speed, air flap 8 is closed, with the result that the entire intake air mass flows through pipe 4 and the following inner pipe 7. In this way, air acts only on the radially inner region of the compressor blades.

Depending on blade geometry, however, it may also be more advantageous not to concentrate the air flow on the center but to feed it to the outer region of the compressor blades. If this is desired, air flap 9 is closed and air flap 8 is opened.

In the embodiment shown here, both air flaps 8, 9 are controlled by a single actuator 10. In this arrangement, the associated mechanism can be designed in such a way, for example, that, during the transition from full load to part load, air flap 8 is closed first and flap 9 begins to throttle the flow only when there is a further reduction in load.

What is claimed is:

1. A compressor of a turbocharger, the compressor comprising:
a compressor housing,
a compressor wheel mounted therein, with compressor blades and a compressor inlet,
wherein the compressor inlet comprises, at least in a section adjacent to the compressor housing, an inner pipe and an outer pipe surrounding said inner pipe,
the inner pipe is directed toward the radially inner region of the compressor blades and the passage cross section of the outer pipe and/or of the inner pipe operable to be at least partially shut off by means of shutoff devices,
wherein the outer pipe is directed toward the radially outer region of the compressor blades,
the compressor inlet comprises two pipes arranged adjacent to one another, of which one is passed into the interior of the other and extends as far as the compressor housing as an inner pipe extending in the outer pipe, and in that the shutoff devices are arranged in at least one of the pipes arranged adjacent to one another.

2. The compressor as claimed in claim 1, wherein the shutoff devices comprise an air flap.

3. The compressor as claimed in claim 1, wherein the shutoff devices comprise a slide.

4. The compressor as claimed in claim 1, further comprising an actuator controlling the shutoff devices based at least in part on an operating parameter of an associated internal combustion engine.

5. The compressor as claimed in claim 4, wherein the operating parameter includes the engine load.

6. The compressor as claimed in claim 4, wherein a single actuator controls the shutoff devices of both pipes.

7. The compressor as claimed in claim 1, wherein the shutoff devices replace a throttle valve in a header pipe.

8. An internal combustion engine comprising:
a compressor housing,
a compressor wheel mounted in the compressor housing, the compressor wheel having compressor blades,
a compressor inlet including, at least in a section adjacent to the compressor housing, an inner pipe and an outer pipe surrounding said inner pipe,
the inner pipe directed toward the radially inner region of the compressor blades and the outer pipe directed toward the radially outer region of the compressor blades,
a set of shutoff devices arranged in at least one of the pipes and operable to at least partially shut off the passage cross section of the outer pipe and/or of the inner pipe.

9. The internal combustion engine as claimed in claim 8, wherein the shutoff devices comprise an air flap.

10. The internal combustion engine as claimed in claim 8, wherein the shutoff devices comprise a slide.

11. The internal combustion engine as claimed in claim 8, further comprising an actuator controlling the shutoff devices based at least in part on an operating parameter of an associated internal combustion engine.

12. The internal combustion engine as claimed in claim 11, wherein the operating parameter includes the engine load.

13. The internal combustion engine as claimed in claim 11, wherein a single actuator controls the shutoff devices of both pipes.

14. The internal combustion engine as claimed in claim 8, wherein the shutoff devices replace a throttle valve in a header pipe.
